(19) United States
(12) Patent Application Publication
(10) Pub. No.: US 2011/0099199 A1
(43) Pub. Date: Apr. 28, 2011

(54) Method and System of Detecting Events in Image Collections

(76) Inventors: Thijs Stalenhoef, (US); Jan Erik Solem, (US); Nikolai Nyholm, (US); Geoff Parker, (US)

(21) Appl. No.: 12/606,221

(22) Filed: Oct. 27, 2009

(51) Int. Cl. G06F 17/30

(52) U.S. Cl. 707/770; 707/E17.014

(57) ABSTRACT

A method and system of combining recognition of objects, backgrounds, scenes and metadata in images with social graph data for automatically detecting events of interest.

### BACKGROUND OF THE INVENTION

Below follows a description of the background technologies and the problem domain of the present invention.

### EXIF: Exchangeable Image File Format

This is an industry standard for adding specific metadata tags to existing file formats such as JPEG and TIFF. It is used extensively by photo camera manufacturers to write relevant meta data to an image file at the point of capture.

The meta data tags used are many and varied, but tend to include the date and time of capture, the camera's settings such as shutter speed, aperture, ISO speed, focal length, metering mode, the use of flash if any, orientation of the image, GPS coordinates, a thumbnail of the image for rapid viewing, copyright information and many others.

The latest version of the EXIF standard is 2.21 and is available from http://www.cipa.jp/exifprint/index_e.html

### GPS: Global Positioning System

A method for determining geographic location based on satellite technology. Dedicated photo cameras with built-in support for this technology are available and many smart-phones with built-in cameras also feature GPS functionality. In those cases the longitude and latitude of the cameras current GPS-retrieved position are written into the resulting file's EXIF meta data upon taking a photo.

### Social Graph

The social graph is a representation of a social structure based on individuals and their inter-dependencies. The nodes of the graph represent individuals and the connections between the nodes define the type of interdependency, such as friendship, kinship, partnership, or any other kind of relationship, including any kind of business relationship. Any number of additional attributes relevant to further specifying the nature of the interdependency can be added, to further enrich the graph.

Relationships between users of any (usually online) service can be expressed as a social graph. Of particular interest are the social graphs of services focused on interaction between users, such as social network services. In particular the social graph of users, their photos and the permissions on who has access to these photos is a relevant graph for the present invention.

Social graphs derived from these services, often through making use of that particular service's Application Programming Interface (if available), tend to be detailed, up-to-date and information-dense.

The social graph or network can be analyzed using mathematical techniques based on network and graph theory. Possible uses range from the provision of user targeted services to facilitating communication and sharing of content as well as behavioral prediction, advertising and market analysis.

### Object Recognition and Computer Vision

Content-based image retrieval (CBIR) is the field of searching for images with similar content as a query image. The term ‘content’ in this context might refer to colors, shapes, textures, or any other information that can be derived from the image itself, cf. [1] for a recent overview. Object recognition, the automatic process of finding similar objects, backgrounds or scenes in a collection of images using computer vision and image analysis, is a sub-field within CBIR most related to the present invention.

The annual PASCAL challenges [2] perform evaluation of algorithms on a challenging and growing data set. Current state-of-the-art object recognition uses local descriptors, often a combination of several different types, applied at detected interest points, sampled densely across the photo or applied globally to the photo itself. Examples of feature descriptors are the SIFT interest point detector and descriptor [3], the HOG descriptor [5] (which both incorporate occurrences of gradient orientation in localized portions of the photo) and other local detectors and descriptors [4]. These and other feature descriptors are also applicable on a global photo level. Object recognition builds on the comparison and analysis of these descriptors, possibly combined with other types of data.

The present invention is not restricted to or dependent upon any particular choice of feature descriptor (local or global) and the above references should be considered as references to indicate the type of descriptors rather than any particular choice.

The present invention describes a method and a system for automatically organizing photos into events, using the data sources mentioned above.

### DETAILED DESCRIPTION

### The Event

An Event is defined as a set of photos taken at the same place and within the same time-span, showing a real-world occurrence. This occurrence could be anything from a social gathering or party to a news-event or a visit to a tourist attraction. In particular, an Event can consist of photos taken by any number of individuals, such as multiple guests at a wedding, each taking their own set of photos, using any number of imaging devices.

Events segment a collection of photos in a way that is natural to a user. At the same time they bind together photos that naturally belong together, even though these photos might come from different people and sources as well as potentially consisting of images in different file formats.

### The Need for Events

All photos shared by all of a user's social relations using all possible online methods quickly adds up to an enormous amount of content. Most of this content tends to be unorganized, as users do not take the time to label photos in a way that facilitates easy retrieval or sharing with individuals for whom these photos have relevance. Therefore most online photos end up unseen and unused.

Events provide an easy to consume organizational structure, that helps makes sense of these large collections of photos. With an entire social graph of photos organized by Events, a user can more easily get an overview of all the content that is available.

Since it is organized logically according to “real world” occurrences, instead of being segmented by photographer, retrieval becomes more natural. All contextually relevant photos are presented together, so it is no longer necessary to look in multiple places to get to see clearly related content.

Events have their own set of meta-data, including but not strictly including or limited to; date and time range, geographic location, a description name or label, organizational tags of any kind and identity information pertaining to the people represented in the photos contained in the Event.

### Creation of Events

While Events can be created manually by people organizing themselves using some existing online service or tool and manually adding their photos of a certain real-world occurrence to a common “album” somewhere, this in practice rarely happens. While the usefulness (as described in the preceding section) is clear, there are several clear problems with this approach:
1. Unfamiliarity with the concept. Online photos are still a relatively new phenomenon and most users still think along the lines of a physical photo-album that only hold one person's photos in one place a time.
2. Lack of tools. Virtually no tools, online or otherwise exist that are made specifically for this purpose. Existing tools or services can be “re-purposed” or adapted to fulfill this function, but this usually has severe limitations as these tools were never designed to facilitate this.
3. Technically difficult. Gathering photos from several sources in one place and organizing them using self-built or repurposed tools and services is technically challenging and therefore out of reach of most regular users.
4. Arduous and time consuming. Although existing tools and service might be able to hold a set of photos and give relevant people access to them, uploading, sorting and otherwise organizing these into a useful and relevant whole takes a lot of time, effort and coordination between users. More time than the average user is likely to want to spend.

The present invention introduce methods for automatically creating Events out of photos by individuals connected through a social graph. Beyond information gathered using the social graph itself, meta-data, EXIF information, GPS coordinates and computer vision technology are used for to segment a collection of photos into Events and to add relevant meta-data to each Event to facilitate retrieval and sharing the Event with people for whom it is relevant.

### Data Sources

The following methods and data sources can be used to segment a collection of photos, correlate these segments with other segments to form Events and provide meta-data to allow each Event to be easily retrieved (through browsing or search) and shared. Using them all in conjunction yields a solid system for organizing photos across online services, social networks and individuals.

### Date and Time (for Segmentation)

Date and time is a powerful way of segmenting photos. Two basic time-stamps are generally available for this in an online scenario: capture time and upload time.

By clustering all photos that were uploaded at the same point in time, a very rough first segmentation of photos can be made. The assumption made here is that photos that were taken of a real world occurrence are generally uploaded all at the same time.

By looking at the capture time, one can further divide the segments from the previous step. This is done by grouping photos were taken no further apart in time than a certain threshold value.

### EXIF Data (for Segmentation)

Segmentation of photos may also be done, or further fine-tuned, by analyzing the EXIF data for each photo.

This can be used to detect rapid changes in scene or subject matter, thus suggesting a segment boundary should be created. The present invention uses the following indicators of a rapid change of scene or subject matter in photos taken sequentially:
1. Significant shift in shutterspeed. Within the same scene/location lighting tends to be generally the same. A major shift indicates the scene/location has changed, for instance because the photographer changes their location from the inside of a building to the outside or vice-versa
2. Use of flash. Most cameras, especially when set up in automatic mode, tend automatically start using flash when the light-level drops. The use of flash can therefore be used to indicate a scene/location change as above. Conversely, a sudden stop in the use of flash, especially when coupled to an increase in shutter-speed does the same.
3. Significant shift in ISO speed. Most cameras change ISO speed automatically as a result of a change in light-levels. The higher the light-level the lower the ISO speed and conversely the higher the ISO speed, the lower the light level. This again indicates a scene/location change.
4. White balance change. Most cameras change their white-balance as a result of scene/location changes. A “incandescent” white balance is used for shots the camera thinks are taken in indoor incandescent light, whereas outdoor shots are taken with “day light” white balance.

### Object Recognition (for Segmentation)

Photos may also be segmented based on overlapping visual appearance. Using an object recognition system, feature descriptors can be computed for each image and compared for potential matches. These feature descriptors may be any type of local descriptors representing regions in the photos, e.g. REF and similar, or global descriptors representing the photo as a whole, e.g. REF and similar.

One example would be to match descriptors between consecutive images to determine discontinuities in visual content, thus suggesting a segment boundary should be created. Another alternative is to match descriptors between any pair of images and thereby determining segments that are not strictly consecutive in time.

### Social Graph (for Correlation)

Based on a user's social graph we can select those individuals judged to be socially close enough to be of interest (friends, family, etc.). The segmented photos from all of these individuals are potentially correlated with those segments from the initial user. By using the further correlation methods described below, segments from different users can be matched to each other in order to build up a final Event.

### Date and Time (for Correlation)

After the collection of segments have been created through the social graph, segments have to be correlated to each other in order to form an Event. As an early step to finding matching segments from other users for the user's own segments one looks for segments whose time-frames overlap.

Each segment has a start and an end time-stamp. The start time-stamp is the time-stamp of the first photo of the segment and conversely the end time-stamp is that of the last photo of the segment.

When either the start or the end time-stamp of a particular segment is between the start and end time-stamps of another segment both segments are determined to overlap.

Any segments that do not overlap based on this method are assumed to be “stand-alone” Events, i.e. Events whose photos are all made by the same photographer. No further processing is done to them.

Overlapping segments become candidate segment clusters. Each segment in the cluster overlaps with at least one other segment. This cluster is sent for further matching using GPS data if available, or face recognition and other computer vision technology otherwise.

### GPS Data (for Correlation)

If two or more segments in candidate segment cluster contain photos with embedded GPS data, or for which location data provided has been otherwise provided, the distances between these locations can be calculated. If one of more photos from one segment have a location that is within a certain threshold distance from those of an other segment, the candidate segments are joined into an Event. Further segment pairs from the cluster can be joined to this Event, should their location also be close enough as well.

This is repeated this for all segments with GPS or other location data.

Any remaining candidate segments from each cluster, that have not yet been joined with others to form an Event are processed using face recognition and other computer vision technology for finding further matches.

### Face Recognition (for Correlation)

Face recognition technology can be used to correlate candidate segments from a cluster to each other and build Events out of them in a number of ways. All of these rely on finding the faces in each photo from every segment and Event previously created using e.g. date, time or GPS co-ordinates. After that one can match the segments using either named or unnamed faces.

### Matching Using Named Faces

Faces can be named in two ways:
1. Manually. The user is present with a face and ask to provide a name for it. This process can be repeated until all faces are named
2. Automatically. Based on a set of already named faces, face recognition technology can automatically name unnamed faces if they appear similar enough based on some threshold value.

The two approaches may be combined, with the user naming some and the system either fully automatically naming further faces that are similar or presenting the user with a list of faces it thinks are the same person and asking the user to verify.

Once a set of faces—though not necessarily all—from each candidate segment or Event has been named, matching can be done. If two or more segments from the candidate segment cluster or previously created Events, have the same person or people named in it, the segments and/or Events are joined together to form a new Event. This based on the principle that the same person cannot be in two places at the same time. Since all segments of the candidate segment cluster overlap in time, and the person appears in photos across several segments or Events, these almost certainly must segments pertaining to one and the same real-world occurrence. When naming, the social graph may be used to uniquely define persons that may have the same name.

### Matching Using Unnamed Faces.

Analogous to the above, one can match segments from a candidate cluster purely together based on face recognition alone, without user interference.

If faces from two or more segments are close enough as determined by the face recognition engine, they are said to be a face-match. If more than a threshold number of these face-matches appear between any number of segments in a cluster or previously created Event, the segments and/or Events are joined up to form a new Event.

### Object Recognition (for Correlation)

If two or more segments in candidate segment cluster contain photos with matching feature descriptors, a similarity score may be calculated indicating the similarity of the photos. Depending on the feature descriptor used either this will indicate either similar objects or similar general photo content. If the similarity score is lower (low score indicating a better match) than some threshold, the candidate segments are joined into an Event.

### Remaining Segment Treatment

At this point all segments in the cluster that could be automatically correlated to other have been combined to form Events. Any segments that remain become separate “stand-alone” Events in their own right, i.e. Events of which all photos are taken by the same photographer.

Now meta-data is collected to help label and tag Events, to make them easier to retrieve and browse.

### Object Recognition (for Meta-Data)

Object recognition technology may be used to automatically extract meta-data for the Event. This enables browsing of Events by the object types appearing in them or by category.

Any state-of-the-art object recognition system, e.g. as those described in the annual PASCAL challenges [2], may be used to describe the content of the photos. To extract meta-data, object recognition is used in two different ways.
Categorization: labels are assigned to the photo on a global level, indicating a category, or a hierarchy of categories, for the photo.
Object localization: labels are assigned to regions in the photo, e.g. by assigning them to bounding boxes, indicating that the label applies to that particular region.

### Face Recognition (for Meta-Data)

The names of all the unique people appearing in the photos of an Event, may be added as meta-data to the Event. This enables browsing of Events by the people in them or search for Events that contain a certain person or group of people.

These names may also become part of the label for the Event, together with the date and time.

### Date and Time (for Meta-Data)

The start and end time-stamps of a particular Event (see previous section) are stored as meta-data for the Event. Should a computer vision technology based or manually provided name or label be lacking, these may become the primary way of referring to an Event.

In an embodiment of the present invention a method for automatic grouping of photos comprising the steps of;
segmenting a collection of photos using any data source, or combination, of social graph, date, time, EXIF and object recognition,
further correlating these segments with other segments using any data source, or combination, of social graph, date, time, GPS, face recognition and object recognition,
providing meta-data to enable retrieval.

In another embodiment of the present invention a computer program stored in a computer readable storage medium and executed in a computational unit for automatic grouping of photos comprising the steps of;
segmenting a collection of photos using any data source, or combination, of social graph, date, time, EXIF and object recognition,
further correlating these segments with other segments using any data source, or combination, of social graph, date, time, GPS, face recognition and object recognition,
providing meta-data to enable retrieval.

Yet another embodiment of the present invention, a system for automatic grouping of photos containing a computer program according to the embodiment above.

In another embodiment of the present invention a system or device is used for obtaining photos by e.g. downloading them from a website, analyzing the photos, store a representation of groups of photos and providing means for retrieving or viewing these groups.

We have described the underlying method used for the present invention together with a list of embodiments.

### REFERENCES

[1] R. Datta, D. Joshi, J. Li, and J. Wang. Image retrieval: Ideas, influences, and trends of the new age. ACM Comput. Serv. 40, 2 (2008).
[2] Everingham, M. and Van Gool, L. and Williams, C. K. I. and Winn, J. and Zisserman, A., The PASCAL Visual Object Classes Challenge 2009 (VOC2009) Results, “http://www.pascal-network.org/challenges/VOC/voc2009/workshop/index.html
[3] D. Lowe, Distinctive Image Features from Scale-Invariant Keypoints, International Journal of Computer Vision, 60, 2, 2004.
[4] K. Mikolajczyk and C. Schmid, Scale and Affine Invariant Interest Point Detectors, International Journal of Computer Vision, 60, 1, 2004.
[5] Qiang Zhu, Shai Avidan, Mei-Chen Yeh, Kwang-Ting Cheng, Fast Human Detection Using a Cascade of Histograms of Oriented Gradients, TR2006-068 June 2006, Mitsubishi Electric Research Laboratories.

1. A method for automatic grouping of photos, belonging to one or more users, comprising the steps of;
segmenting a collection of photos using any data source, or combination, of social graph, date, time, EXIF and object recognition,
further correlating these segments with other segments using any data source, or combination, of social graph, date, time, GPS, face recognition and object recognition,
providing meta-data to enable retrieval.

2. The method according to claim 1, wherein said collection is a user's photo album or parts thereof.

3. The method according to claim 1, wherein said segments are correlated between users of social networks or photo sharing sites.

4. The method according to claim 1, wherein said meta-data is names or identities computed using face recognition.

5. The method according to claim 1, wherein said correlation of segments is performed using face recognition in combination with;
user interaction by any user, or,
pre-labeled faces by any user.

6. The method according to claim 1, wherein said correlation of segments is performed using face recognition on unnamed faces and segments grouped if there are sufficiently many face matches.

7. A computer program stored in a computer readable storage medium and executed in a computational unit for automatic grouping of photos according to claim 1.

8. A system for automatic grouping of photos comprising of a computer program according to claim 7.

9. A system according to claim 8 where the collections are photo albums.

10. A system according to claim 8 where the collections are created across social graphs.
